(19) United States
(12) Patent Application Publication
(10) Pub. No.: US 2006/0288599 A1
(43) Pub. Date: Dec. 28, 2006

(54) Tape apparatus and method for establishing a plurality of locations extending parallel to a reference edge

(75) Inventor: Zoya Hajianpour, Fort Lauderdale, FL (US)

Correspondence Address: RONALD V. DAVIDGE, SUITE 514, 3300 UNIVERSITY DRIVE, CORAL SPRINGS, FL, 33065, US

(73) Assignee: Zoya, Inc.

(21) Appl. No.: 11/158,625

(22) Filed: Jun. 22, 2005

(51) Int. Cl. G01B 3/10

(52) U.S. Cl. 33/755

(57) ABSTRACT

Measurement apparatus is provided for establishing locations at common distances from a number of locations along a reference edge, with such locations being placed along lines extending parallel to the reference edge. The measurement apparatus includes an elongated flexible tape and a number of sliders configured to be slidably held on the tape. The tape and sliders may be provided within a package for retail sale, with the tape being formed in a coil to be readily separated into a number of sections.

### BACKGROUND OF THE INVENTION

1. Field of the Invention

This invention relates to apparatus for establishing locations to paint stripes on a surface such as a wall or to align picture frames, and, more particularly, to apparatus for establishing locations at common distances from a number of locations along a reference edge, with such locations thereby being placed along lines extending parallel to the reference edge.

2. Summary of the Background Art

The patent literature includes a number of descriptions of a elongated flexible tape having a single slider, which is provided with features facilitating particular types of measurements. For example, U.S. Pat. No. 3,744,134 describes a block-like slider mounted on a conventional retractable tape, with the slider having a resilient bottom portion that is squeezed to enable movement of the slider along the tape and released to hold the slider in place on the tape, and with one marginal edge of the slider having a limit stop abutment that can be brought into contact with a measurable surface. U.S. Pat. No. 3,289,305 describes a retractable elongated flexible tape having a slider that can be moved along the tape and locked in place, with both the slider and the tape having markings to be used in determining the proper location of rafters in a roof. U.S. Pat. No. 4,827,622 describes an attachment for a flexible tape measure, in which the attachment has a bracket and a housing holding a magnet is received in the housing and positioned to align with the calibration marks of the tape, providing for additional uses of the tape measure, for example, as a level and a square. What is needed is a measuring device including a tape measure and a plurality of sliders that can be individually positioned to indicate a plurality of locations.

Other patents devices including means for measuring together with a bubble gauge for leveling. For example, U.S. Pat. No. 5,092,057 describes a tool for locating a pair of points on a horizontal line at a desired distance from a reference point. The tool includes an elongated body carrying a pair of spaced-apart, slidably positionable locator members, a scale indicating their horizontal positions, and a bubble gauge indicating when they are horizontally aligned. A tape measure is mounted to be extended perpendicularly to the body member to the reference point. U.S. Pat. No. 6,785,997 describes a measuring and leveling device for allowing objects such as picture frames to be correctly aligned when they are hung from a wall. The device includes an elongated member and a number of sliding carriages, each of which includes a leveling gauge, such as a bubble gauge, to indicate a level orientation of the particular slider. What is needed is a method for aligning picture frames and the like on a wall without requiring the complexity of a number of leveling gauges and further without requiring the alignment device to include a rigid elongated structure.

U.S. Design Pat. No. 320,168 describes a slider for movable attachment to a elongated flexible tape. The slider includes a curved and slotted lower section extending under the tape a pair of tabs extending upward and along the top of the tape being separated by a slot including a round aperture, and a pointed tab extending downward from the lower section. What is needed is a simple transparent plastic slider for fitting over a tape having an opaque surface shaped to provide an unambiguous indication of the location of the slider in comparison with the marked indicia of the tape.

### SUMMARY OF THE INVENTION

In accordance the invention, apparatus and a method is provided for establishing a number of locations extending parallel to a reference edge, such as the edge formed by the intersection of a wall and a ceiling or an edge of a molding extending along a wall. The establishment of a location may involve moving a picture frame or marking a point along which a line is to be painted on a wall.

According to a first aspect of the invention, this apparatus includes an elongated flexible tape and a plurality of sliders slidably attached to move along the elongated flexible tape. Such apparatus may be provided in the form of a package for retail sale including a container, an elongated flexible tape within the container, and a number of sliders configured for slidable attachment to the tape.

A method for using the apparatus includes arranging the sliders along the elongated flexible tape in positions corresponding to the locations to be established, with a distance between a first end of the elongated flexible tape and each of the sliders being equal to a distance of a location to be established from the reference edge. Then, the first end of the elongated flexible tape is held against the reference edge at a first position, as the elongated flexible tape is held outward from the reference edge. Then, the elongated flexible tape is moved, to be held against the reference edge at a second position to establish other points at the same distances from the reference edge. Alternately, a number of sections of the elongated flexible tape, having sliders attached thereto in similar patters, may be held against the reference edge at a number of locations.

### BRIEF DESCRIPTION OF THE DRAWINGS

FIG. 1 is a fragmentary elevation of a measuring device built in accordance with the invention, shown during use;

FIG. 2 is an end elevation of a slider for use within the measuring device of FIG. 1,

FIG. 3 is a plan view of a first version of the slider of FIG. 2;

FIG. 4 is a plan view of a second version of the slider of FIG. 2;

FIG. 5 is a plan view of a third version of the slider of FIG. 2;

FIG. 6 is a plan view of a fourth version of the slider of FIG. 2, and

FIG. 7 is a perspective view of a package for retail sale configured in accordance with the invention.

### DETAILED DESCRIPTION OF THE INVENTION

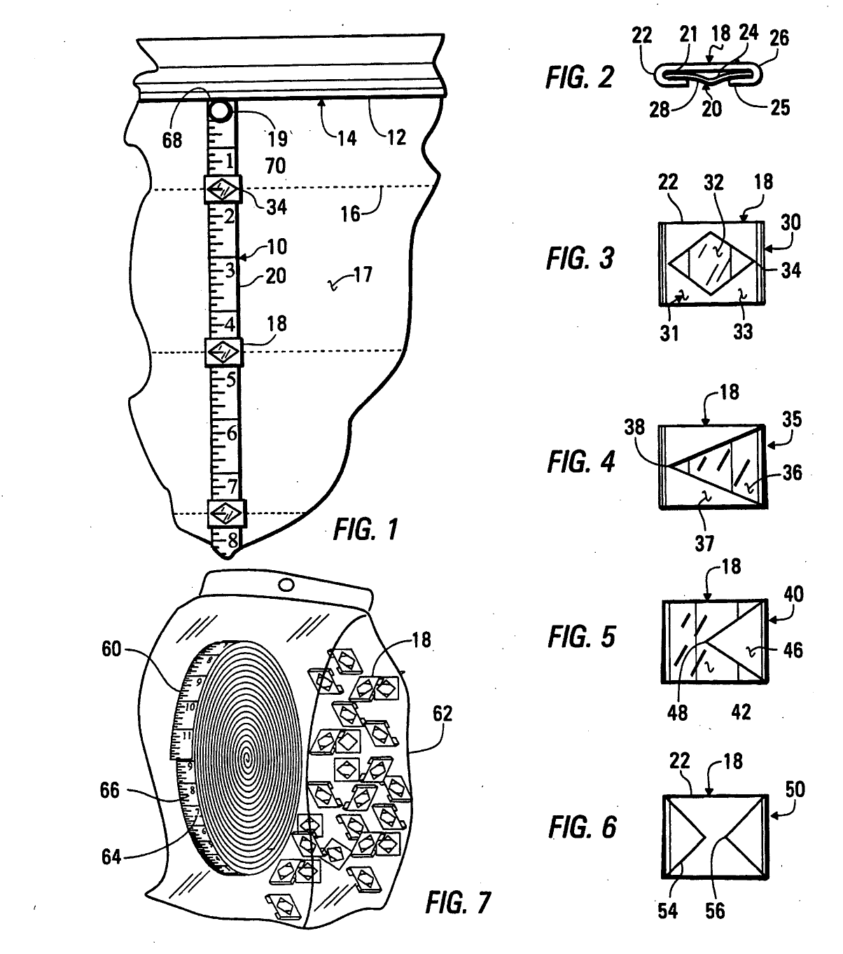

FIG. 1 is a fragmentary elevation of a measuring device 10, assembled in accordance with the invention for use in establishing a number of location points along lines extending parallel to a reference line 12. In the example of the figure, the reference line 12 is formed by a lower edge of a molding strip 14, and the measuring device 10 is set to establish points along three lines, indicated by dashed lines 16, extending along a wall 17 parallel to the reference line 12 and located by the positions of three sliders 18 disposed along a elongated flexible tape 20. Thus, the measuring device 10 is seen to comprise a elongated flexible tape 20 and a plurality of sliders 18, each of which can be slid along the elongated flexible tape 20, and each of which remains in clamped in position on the tape 20 when it is not being slid. The lines 16 may be, for example, the upper edges of a number of picture frames that are being aligned on a wall, or edges of stripes to be painted on the wall. The reference edge 12 may alternately be, for example, the lower surface of a ceiling above the wall on which articles are to be aligned. The tape 20 may be temporarily held in place against the reference edge 12 by a tack extending into the wall 17.

FIG. 2 is an end view of a slider 18 for use in the measuring device 10, shown with the elongated flexible tape 20 extending through a slot 21 therein. The slider 18 includes a first portion 22 extending across the elongated flexible tape 20 adjacent a first side 24 of the tape 20 and a pair of tabs 25 extending from lateral edges 26 of the first portion 22 around parts of a side 28 of the tape 20 opposite the first side 24 thereof. Preferably, the slot 21 is configured so that the tape 20 is buckled along its width as it is inserted within the slot 30. In this way, the slider 18 is slidably retained in place on the tape 20 through deformation of the tape 20. Alternately, the tabs 25 may be configured to be resiliently deflected by the insertion of the tape 20.

FIG. 3 is a plan view of a first version 30 of the slider 18, which is composed of a transparent thermoplastic material partly covered with an opaque coating. The first portion 22 of this slider version 30 to has an upper surface 31 with a transparent portion 32 and an opaque portion 33, formed by the application of the opaque coating. When the slider 18 is attached to the elongated flexible tape 20, markings on the tape 20 are visible through the transparent portion 32, with outward extending points 34 of the transparent portion 32 being used to align the center of the slider 18 along the elongated flexible tape 20. Central alignment in this way is preferable over edge alignment, since confusion over whether the upper or lower edge of a slider should be aligned is eliminated.

FIG. 4 is a plan view of a second version 35 of the slider 18 for use in the measuring device 10. This slider 35 is similar to the slider 30, described above in reference to FIG. 3, except that the transparent portion 36 of the upper surface 37 extends as a triangle to a single point 38, which is used to align the center of this slider version 35 along the elongated flexible tape 20.

FIG. 5 is a plan view of a third version 40 of a slider for use in the measuring device 10. This slider 40 is also similar to the slider 18, except that the transparent portion 42 of the upper surface 44 extends along the greater part of this surface 44, with a triangular opaque portion 46 extending to a point 48 used to align the center of the slider 40 along the elongated flexible tape 20.

FIG. 6 is a plan view of a fourth version 50 of a slider for use in the measuring device 10, which is composed entirely of an opaque material that can be thermoplastic or metallic. The first section 22 extends below a pair of tabs 54, which extend upward and inward to a pair of points 56 used to align the center of the slider 50 along the elongated flexible tape 20.

FIG. 7 is a perspective view of a package for retail sale configured in accordance with the invention to include a coil of elongated flexible tape 60 and a number of sliders 18 that are configured to slidably engage the tape 60, held within a container 62, such as a bag that is transparent to reveal its contents. Preferably, the elongated flexible tape 60 includes printed markings 64 indicating distances along the tape 80 in a conventional measurement system, such as inches or centimeters. The elongated flexible tape 60 is preferably composed of a paper or fabric material that is low in cost and easily cut to desired lengths. The printed markings 64 may form a repeating pattern, such as a pattern 12 inches or 20 cm in length, so that the tape can be cut into a number of matching portions. The separation of the elongated flexible tape 60 into sections may further be facilitated by lines of perforations 66 extending across the width of the tape 60 in various locations.

To establish a plurality of locations extending parallel to the reference edge, the measuring device 10, as shown in FIG. 1, is assembled, with a plurality of sliders 18 being arranged in locations corresponding to the plurality of locations being established. A distance between the first end 68 of the elongated flexible tape 20 and each of the sliders 18 is set to be equal to the distance between the reference edge 12. The first end 68 of the elongated flexible tape 20 is then held against the reference edge 18, with the elongated flexible tape stretched outward from the reference edge 18. For example, the tack 19 may be used to hold the first end 68 against the reference edge, while gravity is used to hold the elongated flexible tape 20 stretched outward. The distance from the reference edge 12 to each of the sliders 18 is measured, for example to a point 34 mid-way between the ends 70 of the slider 18 through which the tape 20 extends, with this point 34 being established at and edge of transparent and opaque portions of the slider 18. The establishment of a location may result, for example, in making a mark on the wall 17 to indicate an edge of a stripe to be painted on the wall, or in the movement of an edge of a picture frame into place at the desired distance from the reference edge 12.

Next, the measuring device 10 is moved to another location along the reference edge 12 to be held against the reference edge 12 again for the establishment of a number of locations at similar distances from the reference edge 12. This process is repeated as many times as needed to establish the locations required. Alternately, a number of similar measuring devices 10 may be assembled for simultaneous use at various locations along the reference edge 12.

While the invention has been described in its preferred versions with some degree of particularity, it is understood that this description has been given only by way of example, and that numerous variations may be achieved without departing from the spirit and scope of the invention, as defined in the appended claims.

What is claimed is:

1. Apparatus comprising:
an elongated flexible tape; and
a plurality of sliders slidably attached to move along the elongated flexible tape.

2. The apparatus of claim 1, wherein
each slider within the plurality of sliders is composed of a transparent thermoplastic resin partly covered by an opaque coating,
each slider within the plurality of sliders includes a slot through which the elongated flexible tape extends between ends of the slider and an upper section extending above the slot, and
the upper section includes an opaque portion having an outer surface covered by the opaque covering, and a transparent portion.

3. The apparatus of claim 2, wherein the transparent portion extends as a diamond-shaped area to a pair of points mid-way between the ends of the slider.

4. The apparatus of claim 2, wherein the transparent portion extends as a triangular area to a point mid-way between the ends of the slider.

5. The apparatus of claim 2, wherein the opaque portion extends as a triangular area to a point mid-way between the ends of the slider.

6. The apparatus of claim 1, wherein
each slider within the plurality of sliders includes a first portion extending across the elongated flexible tape adjacent a first side of the flexible tape, and a pair of tabs extending from ends of the first portion around parts of a side of the flexible tape opposite the first side of the flexible tape and
the pair of tabs are configured to buckle the flexible tape along its width as the tape is inserted adjacent the first portion of the slider.

7. The apparatus of claim 1, wherein the elongated flexible tape includes a surface having a number of marked indicia including numerals indicating lengthwise distances along the elongated flexible tape.

8. A package for retail sale comprising:
a container.
an elongated flexible tape within the container, and
a plurality of sliders configured for slidable attachment to move along the elongated flexible tape within the container.

9. The package of claim 8 wherein the elongated flexible tape includes a surface having a number of marked indicia including numerals indicating lengthwise distances along the elongated flexible tape.

10. The package of claim 9, wherein
the marked indicia including numerals indicating lengthwise distances along the elongated flexible tape is formed as a repeating pattern, and
the elongated flexible tape is easily separable into sections.

11. The package of claim 10, wherein the elongated flexible tape is composed of a material that is easily separable by cutting.

12. The package of claim 10, wherein the elongated flexible tape is perforated for separation into sections disposed along its length.

13. The package of claim 9, wherein
each slider within the plurality of sliders is composed of a transparent thermoplastic resin partly covered by an opaque coating,
each slider within the plurality of sliders includes a slot through which the elongated flexible tape extends between ends of the slider and an upper section extending above the slot, and
the upper section includes an opaque portion having an outer surface covered by the opaque covering, and a transparent portion.

14. The package of claim 9 wherein
each slider within the plurality of sliders includes a first portion extending across the elongated flexible tape adjacent a first side of the flexible tape, and a pair of tabs extending from lateral edges of the first portion around parts of a side of the flexible tape opposite the first side of the flexible tape and
the pair of tabs are configured to buckle the flexible tape along its width as the tape is inserted adjacent the first portion of the slider.

15. A method for establishing a plurality of locations extending parallel to a reference edge, wherein the method comprises:
arranging a first plurality of sliders along an elongated flexible tape in positions corresponding to the plurality of locations, wherein a distance between a first end of the elongated flexible tape and each of the sliders equals a distance between the reference edge and a location within the plurality of locations; and
holding the first end of the elongated flexible tape against the reference edge at a first position with the elongated flexible tape stretched outward from the reference edge.

16. The method of claim 15, wherein the elongated flexible tape is stretched downward from the reference edge by gravity.

17. The method of claim 15, additionally comprising:
arranging another plurality of sliders along another elongated flexible tape in positions corresponding to the plurality of locations, wherein a distance between a first end of the other elongated flexible tape and each of the sliders in the other plurality of sliders equals a distance between the reference edge and a location within the plurality of locations and
holding the first end of the other elongated flexible tape against the reference edge with the elongated flexible tape stretched outward from the reference edge.

18. The method of claim 17, wherein
each of the sliders includes a top surface having a transparent portion and an opaque portion, with an edge between the transparent and opaque portions extending to a point mid-way between ends of the slider through which the elongated flexible tape extends, and
each distance between the end of the elongated flexible tape and a slider within a plurality of sliders is measured to the point mid-way between ends of the slider.

19. The method of claim 15, additionally comprising holding the elongated flexible tape against the reference edge at a second position, spaced apart from the first position, with the elongated flexible tape stretched outward from the reference edge.

20. The method of claim 19, wherein
each of the sliders includes a top surface having a transparent portion and an opaque portion, with an edge between the transparent and opaque portions extending to a point mid-way between ends of the slider through which the elongated flexible tape extends, and
each distance between the end of the elongated flexible tape and a slider within a plurality of sliders is measured to the point mid-way between ends of the slider.
